(19) United States
(12) Patent Application Publication
(10) Pub. No.: US 2023/0191534 A1
(43) Pub. Date: Jun. 22, 2023

(54) SURFACE PROCESSING EQUIPMENT AND SURFACE PROCESSING METHOD

(71) Applicant: Industrial Technology Research Institute, Hsinchu (TW)

(72) Inventors: Chih-Chieh Chen, Taoyuan City (TW); Kao-Der Chang, Taichung City (TW); Chih-Chiang Weng, Taoyuan City (TW); Yo-Sung Lee, New Taipei City (TW)

(73) Assignee: Industrial Technology Research Institute, Hsinchu (TW)

(21) Appl. No.: 17/953,338

(22) Filed: Sep. 27, 2022

(30) Foreign Application Priority Data
Dec. 17, 2021 (TW) 110147534

(51) Int. Cl. B23K 26/352; B23K 26/03; B23K 26/073; B23K 26/14; B23K 26/08

(52) U.S. Cl. CPC B23K 26/352; B23K 26/032; B23K 26/073; B23K 26/14; B23K 26/0823

(57) ABSTRACT

A surface processing equipment using an energy beam including a measuring device, a gas source, an energy beam supply device, a multi-axis platform, and a processing device is provided. The measuring device measures a workpiece to obtain surface form information. The energy beam supply device receives a processing gas to form an energy beam. The energy beam supply device includes a rotating sleeve. Openings are on a bottom surface of the rotating sleeve. The rotating sleeve rotates along a rotation axis and supplies the energy beam from one of the openings to the workpiece. The processing device controls the gas source, the energy beam supply device, and the multi-axis platform according to the surface form information. Distances from each opening to the rotation axis are all different. The energy beam is formed into a beam shape or rings having different radii via a rotation of the energy beam supply device.

### CROSS-REFERENCE TO RELATED APPLICATION

This application claims the priority benefit of Taiwan application serial no. 110147534, filed on Dec. 17, 2021. The entirety of the above-mentioned patent application is hereby incorporated by reference herein and made a part of this specification.

### TECHNICAL FIELD

The disclosure relates to a processing equipment and a processing method, and more particularly, to a surface processing equipment using an energy beam and a surface processing method.

### BACKGROUND

As far as the current surface polishing field is concerned, the current polishing methods may be divided into traditional full-area polishing and non-traditional local-area polishing. Normally, German and American manufacturers all adopt traditional full-area polishing. But for high-precision requirements and local trimming, magnetorheological finishing (MRF) or ion beam finger (IBF) is adopted.

The principle of IBF is to use a high-energy ion beam to bombard and remove atoms on the surface of the lens. Since the amount of removal is at the atomic scale, a form error of 0.02λ may be reached, so that IBF is mainly used in fabricating Optics for applications such as satellites and military equipment. However, IBF can only operate under vacuum condition, high equipment operation costs and atomic-scale removal results in long processing times, making IBF still mainly used in academic and research institutions. The MRF technique has higher production efficiency than IBF, and form error may reach 0.05λ. However, the construction cost of the equipment is still dozens of times higher than the traditional one, which may not be suitable for the mass production line, and the desired polishing liquid is micron-scale high magnetic permeability particles, which are prone to rust due to oxidation, and therefore the polishing liquid is unrecyclable. In addition, The above two polishing systems do not have an integrated topography detection system, so the area to be processed can only be measured by off-line detection equipment to determine the coordinates of the area to be processed.

Therefore, how to integrate the polishing system with the detection system online and use the energy beam to etch and remove the surface of the lens to achieve the object of high precision and reduce irregularity is an important object in the art.

### SUMMARY

The disclosure provides a surface processing equipment and a surface processing method that may use the composite machining sequence plans of a beam-shaped energy beam and a ring-shaped energy beam to process a workpiece.

The disclosure provides a surface processing equipment using an energy beam including a measuring device, a gas source, an energy beam supply device, a multi-axis platform, and a processing device. The measuring device is adapted to measure a workpiece to obtain surface form information. The gas source is adapted to provide a processing gas. The energy beam supply device is connected to the gas source and adapted to receive the processing gas to form an energy beam. The energy beam supply device includes a rotating sleeve. The rotating sleeve includes a plurality of openings and a plurality of first gas flow channels respectively communicated with the plurality of openings. The plurality of openings are located on a bottom surface of the rotating sleeve. A cylindrical symmetry center of the rotating sleeve has a rotation axis, and the rotating sleeve is adapted to rotate along the rotation axis and provide the energy beam from one of the plurality of openings to the workpiece for processing. The multi-axis platform is adapted to carry the workpiece and move the workpiece to a detection shaft of the measuring device, or move the workpiece to a transmission path of the energy beam. The processing device is electrically connected to the measuring device, the gas source, the energy beam supply device, and the multi-axis platform. The processing device controls the gas source, the energy beam supply device, and the multi-axis platform according to the surface form information, wherein distances from each of the openings to the rotation axis are all different. The energy beam is formed into one of a beam shape or a plurality of rings having different radii via a rotation of the energy beam supply device.

The disclosure further provides a surface processing method using an energy beam, including the steps of establishing a plurality of machining sequence plans, and the plurality of machining sequence plans include providing an energy beam having a beam shape and a plurality of rings having different radii; measuring a workpiece to obtain surface form information; calculating the plurality of machining sequence plans according to the surface form information to obtain a machining process; controlling an energy beam supply device according to the machining process; and providing the energy beam to the workpiece. In particular, the energy beam supply device is adapted to rotate along a rotation axis and provide the energy beam from one of a plurality of openings to the workpiece for processing, and minimum distances from each of the plurality of openings to the rotation axis are all different.

Based on the above, in the surface processing equipment using the energy beam and the surface processing method of the disclosure, the surface processing equipment includes the measuring device, the energy beam supply device, the gas source, and the processing device. The measuring device is adapted to measure the surface of the workpiece to obtain the surface form information. The energy beam supply device is adapted to provide the energy beam to the workpiece for processing. The processing device is electrically connected to the measuring device, the gas source, and the energy beam supply device, and controls the gas source and the energy beam supply device according to the surface form information. Therefore, the surface finishing process of the workpiece may be performed in a non-contact manner, such as surface shape trimming, and the operating parameters of the energy beam supply device may be adjusted via the surface form information obtained by surface form measurement. In addition, the energy beam supply device is adapted to rotate along the rotation axis, and the energy beam may be formed into an energy beam having a beam shape or a plurality of rings having different radii via the rotation of the energy beam supply device for surface processing. In this way, the workpiece may be processed by the composite machining sequence plans of the beam-shaped energy beam and the ring-shaped energy beam.

Several exemplary embodiments accompanied with figures are described in detail below to further describe the disclosure in details.

### BRIEF DESCRIPTION OF THE DRAWINGS

FIG. 1A and FIG. 1B are respectively schematic diagrams of a surface processing equipment in different states of an embodiment of the disclosure.

FIG. 2 is a schematic side view of the energy beam supply device and the workpiece in FIG. 1B.

FIG. 3 is a schematic bottom view of the energy beam supply device of FIG. 2.

FIG. 4 is a schematic three-dimensional view of the energy beam supply device of FIG. 2.

FIG. 5 is a schematic three-dimensional view of the energy beam supply device of FIG. 4.

FIG. 6 is a schematic exploded view of the energy beam supply device of FIG. 4.

FIG. 7 is a three-dimensional perspective view of the rotating sleeve in FIG. 4.

FIG. 8A to FIG. 8F are respectively schematic three-dimensional views of the rotating sleeve of FIG. 7 in different states.

FIG. 9A to FIG. 9F are respectively schematic bottom views of the rotating sleeve of FIG. 8A to FIG. 8F.

FIG. 10 is a schematic three-dimensional view of the energy beam supply device of FIG. 4 in another state.

FIG. 11 is a flowchart of steps of a surface processing method of an embodiment of the disclosure.

FIG. 12 is a schematic diagram of processing simulation of different energy beams of an embodiment of the disclosure.

### DETAILED DESCRIPTION OF DISCLOSED EMBODIMENTS

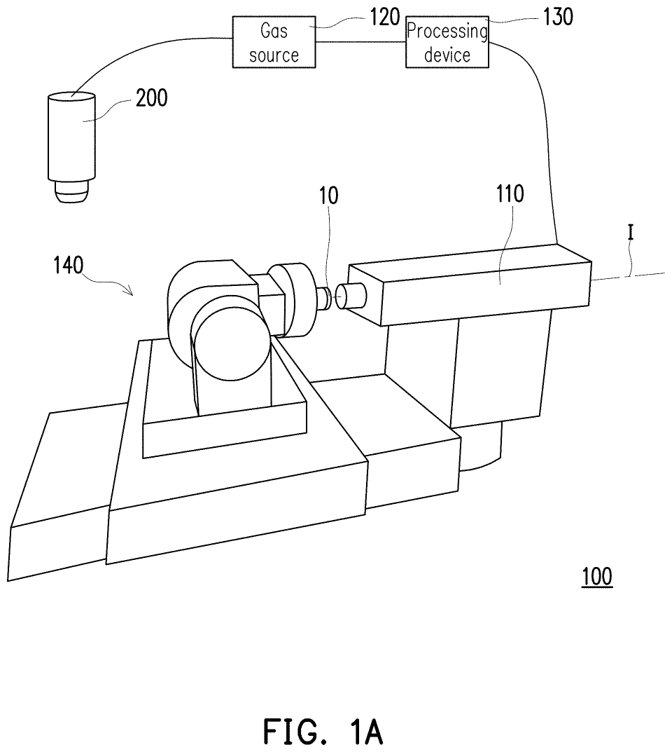

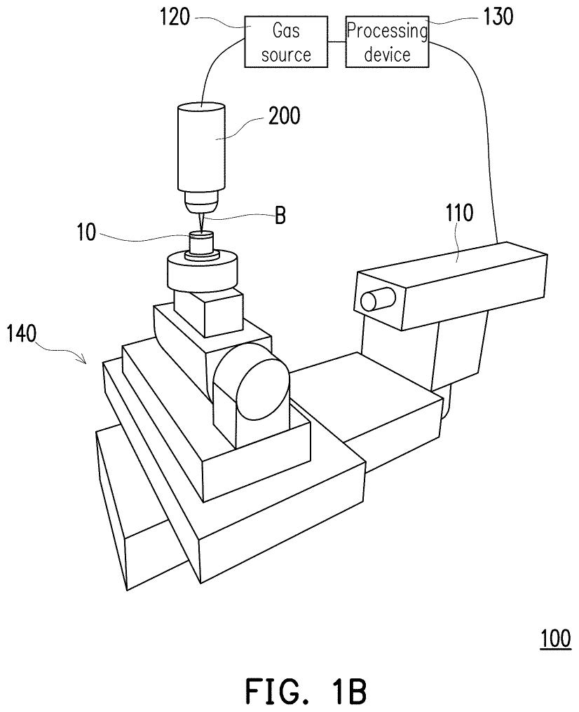

FIG. 1A and FIG. 1B are respectively schematic diagrams of a surface processing equipment in different states of an embodiment of the disclosure. Please refer to FIG. 1A and FIG. 1B. The present embodiment provides a surface processing equipment 100, including a measuring device 110, a gas source 120, an energy beam supply device 200, and a processing device 130. The surface processing equipment 100 is adapted to process a workpiece 10. Specifically, the workpiece 10 is, for example, an optical lens, and the surface processing equipment 100 is adapted to perform a surface processing procedure on the workpiece 10, such as polishing, grinding, and the like. Compared with the conventional processing equipment, the surface processing equipment 100 of the present embodiment is a processing equipment measuring the surface form of the workpiece 10 in a non-contact manner and performs surface modification on the workpiece 10 using an energy beam B.

The measuring device 110 is adapted to measure the workpiece 10 to obtain surface form information, such as height information of any position on the surface of the workpiece 10. Specifically, the surface processing equipment 100 further includes a multi-axis platform 140 adapted to carry the workpiece 10 and move the workpiece 10 to a detection axis I of the measuring device 110, or move the workpiece 10 to the transmission path of the energy beam B. In addition, the multi-axis platform 140 is controlled to move the workpiece 10 to the processing position in real time according to the requirements of the processing, so as to achieve the object of precision processing. In the present embodiment, the multi-axis platform 140 is adapted to fix the workpiece 10 and may rotate to make the workpiece 10 face the measuring device 110, as shown in FIG. 1A. Therefore, when the multi-axis platform 140 moves the workpiece 10 to the detection axis I facing the measuring device 110, the measuring device 110 measures the workpiece 10 to sense the surface form information of the workpiece 10. In an embodiment, the measuring device 110, for example, performs height measurement at any position on the surface of the workpiece 10 to obtain surface form information. In an embodiment, the measurement device 110 is, for example, an optical interferometer or a contact profilometer. That is, for example, contact or non-contact measurement is performed on the workpiece 10, but the disclosure is not limited thereto.

The gas source 120 is connected to the energy beam supply device 200 and adapted to provide a processing gas F (as shown in FIG. 5) to form an ion beam as the energy beam B. In an embodiment, the gas source 120 may adopt a combination of a main gas and at least one reactive gas. For example, the processing gas F provided by the gas source 120 includes, for example, a main gas and a reactive gas. For example, the main gas may be inert gas such as argon (Ar) or neon (Ne), and the reactive gas may be selected from carbon tetrafluoride (CF₄), nitrogen trifluoride (NF₃), nitrogen (N₂), or oxygen (O₂). The mixed gas is controlled by the gas mass/volume flow controller to control the combined ratio of the gas flowing into the energy beam supply device 200.

The processing device 130 is electrically connected to the measuring device 110, the gas source 120, the energy beam supply device 200, and the multi-axis platform 140. The processing device 130 controls the gas source 120, the energy beam supply device 200, and the multi-axis platform 140 according to the surface form information provided by the measuring device 110 to further adjust the working parameters of the gas source 120 and the energy beam supply device 200, such as power, time, frequency, working distance, and the like. Moreover, the processing device 130 obtains the machining process according to the surface form information, and controls the multi-axis platform 140 according to the machining process to drive the workpiece 10 to the processing position in real time so as to precisely process the energy beam B supplied by the energy beam supply device 200. In the present embodiment, the processing device 130 is, for example, a central processing unit (CPU) or a programmable general-use or special-use microprocessor, digital signal processor (DSP), programmable controller, application-specific integrated circuit (ASIC), or other similar elements or a combination of the elements. In addition, the processing device 130 may be electrically connected to the energy beam supply device 200 in a wired or wireless manner, and the disclosure is not limited thereto.

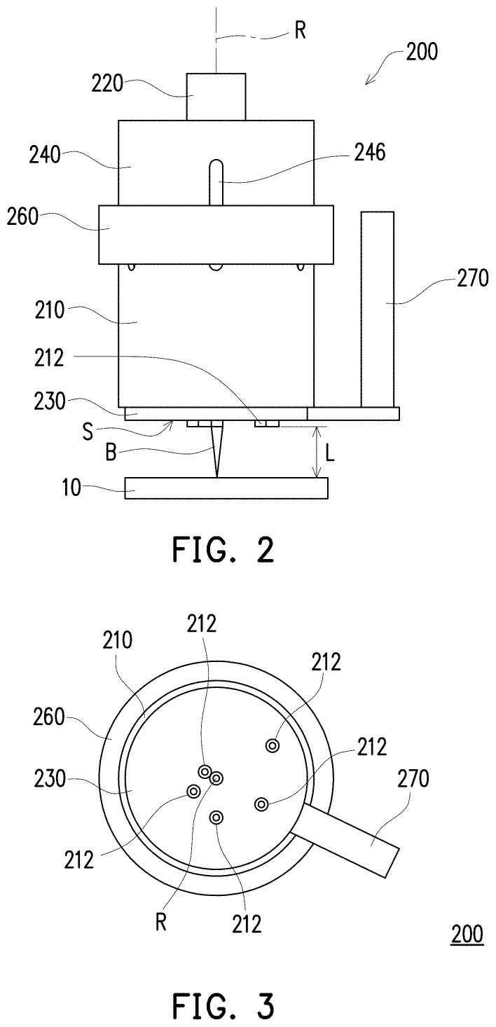

FIG. 2 is a schematic side view of the energy beam supply device and the workpiece in FIG. 1B. Please refer to FIG. 2. The energy beam supply device 200 is connected to the gas source 120 and adapted to receive the processing gas F provided by the gas source 120. The energy beam supply device 200 forms the processing gas F into the energy beam B when performing surface processing. In addition, the energy beam supply device 200 is adapted to rotate along a rotation axis R and supply the energy beam B from one of a plurality of openings 212 to the workpiece 10 for processing. It is worth mentioning that there is a working distance L from the openings 212 of the energy beam supply device 200 to the workpiece 10, and the working distance L is greater than zero. In the present embodiment, the processing method of the present embodiment is a non-contact processing method. In addition, the processing method may be performed in a state where the ambient pressure is substantially in or around standard atmospheric pressure.

FIG. 3 is a schematic three-dimensional view of the energy beam supply device in FIG. 2. Please refer to FIG. 2 and FIG. 3. The distances from the plurality of openings 212 of the energy beam supply device 200 to the rotation axis R can be all different. For example, in the present embodiment, the number of the plurality of openings 212 is six, and the distances from the openings 212 to the rotation axis R are respectively 0 mm, 1 mm, 2 mm, 3 mm, 4 mm, and 5 mm. In addition, the energy beam supply device 200 is adapted to rotate along the rotation axis R, and the energy beam B emits a beam-shaped energy beam B or a ring-shaped energy beam B from one of the plurality of openings 212. Therefore, when the energy beam B is emitted from the openings 212 at a distance of 0 mm from the rotation axis R, the energy beam B is formed into a beam shape. If the energy beam B is emitted from the openings 212 with a distance from the rotation axis R greater than 0 mm, a ring-shaped energy beam B is formed by high-speed rotation. The size of the energy beam B is determined according to the openings 212 at different positions. However, the disclosure does not limit the number of the openings 212 and the distance from each other to the rotation axis R, which may be planned and designed according to different types of workpieces 10. In this way, the workpiece 10 may be processed by the composite machining sequence plans of the beam-shaped energy beam B and the ring-shaped energy beam B.

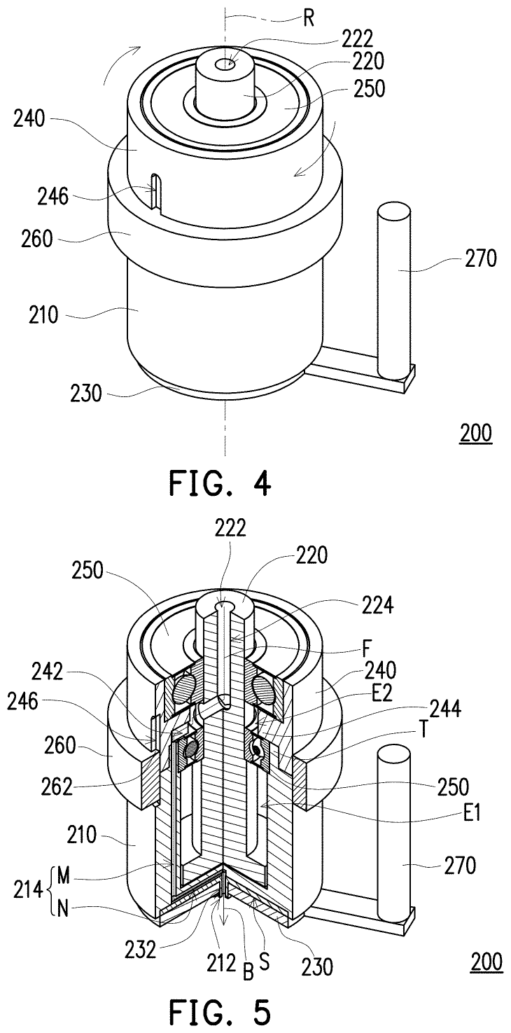

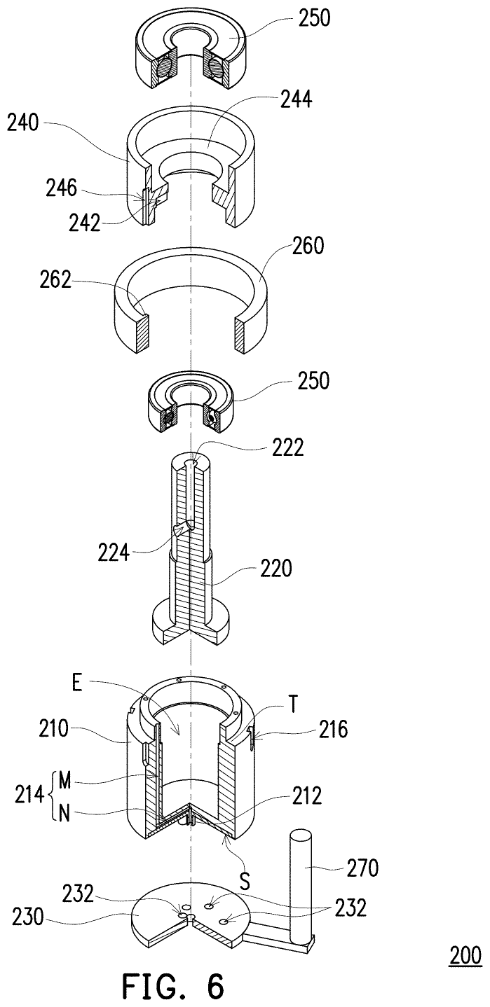

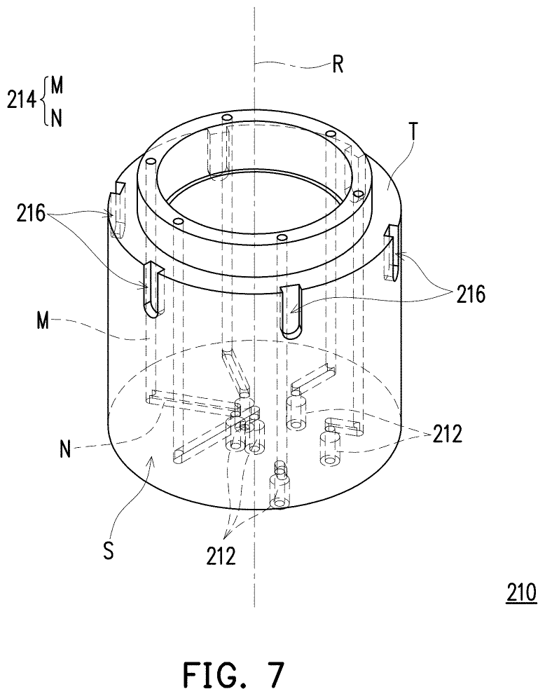

Please refer to FIG. 4 to FIG. 7. FIG. 4 is a schematic three-dimensional view of the energy beam supply device of FIG. 2. FIG. 5 is a schematic three-dimensional view of the energy beam supply device of FIG. 4. FIG. 6 is a schematic exploded view of the energy beam supply device of FIG. 4. FIG. 7 is a three-dimensional perspective view of the rotating sleeve in FIG. 4. In detail, in the present embodiment, the energy beam supply device 200 further includes a rotating sleeve 210, a first electrode 220, a second electrode 230, and a gas channel selector 240. The rotating sleeve 210 includes a space E1, the plurality of openings 212, and a plurality of first gas flow channels 214 respectively communicated with the plurality of openings 212. In particular, the plurality of openings 212 are located on a bottom surface S of the rotating sleeve 210, and the rotation axis R is the central axis of the rotating sleeve 210. The first electrode 220 is disposed in the space E1, and the first electrode 220 includes a gas inlet 222 and a second gas flow channel 224 communicated with the gas inlet 222. In particular, the gas inlet 222 is connected to the gas source 120. The second electrode 230 is disposed on the bottom surface S of the rotating sleeve 210 to cover the bottom surface S, and has a plurality of through holes 232 adapted to allow the plurality of openings 212 of the rotating sleeve 210 to communicate with the outside. In other words, the number and location of the through holes 232 correspond to the number and location of the openings 212 of the rotating sleeve 210. The rotating sleeve 210 is located between the first electrode 220 and the second electrode 230 and adapted to apply an electric field to the processing gas F to form the energy beam B. In addition, in the present embodiment, the energy beam supply device 200 further includes a conductive structure 270 connected to the second electrode 230. The conductive structure 270 is, for example, an electrical brush adapted to provide a grounding function.

Please refer to FIG. 4 to FIG. 6. The gas channel selector 240 is rotatably disposed on a top portion T of the rotating sleeve 210. The gas channel selector 240 includes a third gas flow channel 242 and a blocking portion 244. Moreover, in the present embodiment, the energy beam supply device 200 further includes at least one rotating bearing 250 disposed between the gas channel selector 240 and the rotating sleeve 210 and adapted to allow the gas channel selector 240 and the rotating sleeve 210 to rotate along the rotation axis R. However, the disclosure does not limit the type of mechanism adapted for rotation. It should be mentioned that, the gas channel selector 240 is disposed on the top portion T of the rotating sleeve 210 to form a ring-shaped gas storage space E2 between the shaft structure of the first electrode 220 extended toward the top portion T and the rotating bearing 250 and adapted to store the processing gas F. Therefore, when the gas source 120 provides the processing gas F, the processing gas F enters through the gas inlet 222 and passes through the second gas flow channel 224 to completely fill the gas storage space E2. The gas channel selector 240 is rotated so that the third gas flow channel 242 is communicated between the gas storage space E2 and one of the plurality of first gas flow channels 214, that is, the corresponding first gas flow channel 214, and the blocking portion 244 covers the remaining plurality of first gas flow channels 214 to block the inflow of the processing gas. In this way, the openings 212 to be used may be determined for processing by controlling the position of the third gas flow channel 242 in the gas channel selector 240. In other words, the processing gas F supplied by the gas source 120 passes through the second gas flow channel 224, the gas storage space E2, and the third gas flow channel 242 in order via the gas inlet 222 of the first electrode 220, wherein one first gas flow channel 214 and the corresponding opening 212 are formed as the energy beam B.

More specifically, the number of the plurality of first gas flow channels 214 is the same as the number of the plurality of openings 212, and the plurality of first gas flow channels 214 and the plurality of openings 212 correspond to and are communicated with each other. The lengths of the plurality of first gas flow channels 214 are all different. Specifically, in the present embodiment, each of the first gas flow channels 214 includes a first portion M and a second portion N, wherein the first portion M is communicated with the second portion N, the lengths of the first portions M are all the same and the first portions M are parallel to the extending direction of the rotating sleeve 210, and the lengths of the second portions N are all different and the second portions N are perpendicular to the extending direction of the rotating sleeve 210, as shown in FIG. 7. In detail, the length of each of the second portions N varies with the distance from the corresponding opening 212 to the rotation axis R. If the distance between the opening 212 and the rotation axis R is greater, the length of the corresponding second portion N is smaller, and the sums of the distance from each of the corresponding openings 212 to the rotation axis R and the second portion N are equal to each other and less than the radius of the cylindrical structure of the rotating sleeve 210. In other words, the sums of the distance from each of the openings 212 to the rotation axis R and the length of each of the corresponding first gas flow channels 214 are all the same. Specifically, when the processing gas F flows through the second portion N of the first gas flow channel 214, the processing gas F is excited by the electric field applied between the first electrode 220 and the second electrode 230 to form a plasma state. In turn, the energy beam B is supplied to the workpiece 10 via the opening 212.

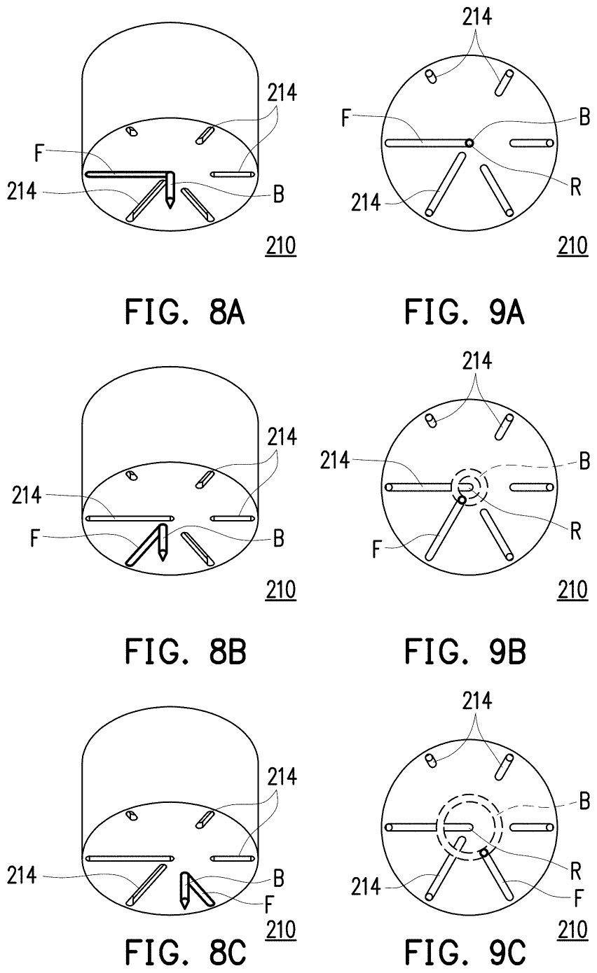

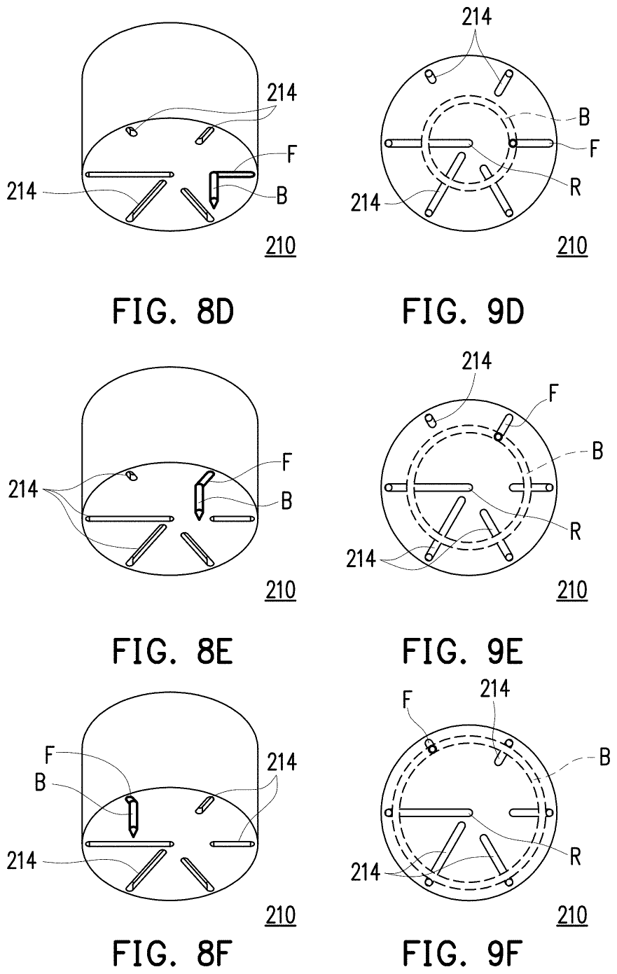

FIG. 8A to FIG. 8F are respectively schematic three-dimensional views of the rotating sleeve of FIG. 7 in different states. FIG. 9A to FIG. 9F are respectively schematic bottom views of the rotating sleeve of FIG. 8A to FIG. 8F. Please refer to FIG. 8A to FIG. 9F. For example, the number of the openings 212 is six, and the distances from the openings 212 to the rotation axis R are respectively 0 mm, 1 mm, 2 mm, 3 mm, 4 mm, and 5 mm (hereinafter referred to as the first opening, the second opening . . . and so on). During the surface processing procedure, when the first opening is to be used for processing, the gas channel selector 240 is controlled to rotate so that the third gas flow channel 242 is communicated with the corresponding first gas flow channel 214. Therefore, a beam-shaped energy beam B may be supplied, as shown in FIG. 8A and FIG. 9A. When the second/third/fourth/fifth/sixth opening 210 is to be used for processing, the gas channel selector 240 is controlled to rotate so that the third gas flow channel 242 is communicated with the corresponding second/third/fourth/fifth/six first gas flow channel 214, so as to provide a beam-shaped energy beam B at the second/third/fourth/fifth/sixth opening 210. Next, the rotating sleeve 210 is then controlled by the processing device 130 to rotate, thereby driving the second/third/fourth/fifth/sixth opening 210 to rotate along the rotation axis R. Therefore, the beam-shaped energy beam B may be rotated to form a ring-shaped energy beam B with a radius of 1 mm/2 mm/3 mm/4 mm/5 mm, as shown in FIG. 8B to FIG. 8F and FIG. 9B to FIG. 9F. Specifically, when the ring-shaped energy beam B is to be formed, the rotating sleeve 210, the second electrode 230, and the gas channel selector 240 are rotated relative to the first electrode 220 via the rotating bearing 250. In the present embodiment, the central angles of any two adjacent second portions N are the same, and the disclosure is not limited thereto.

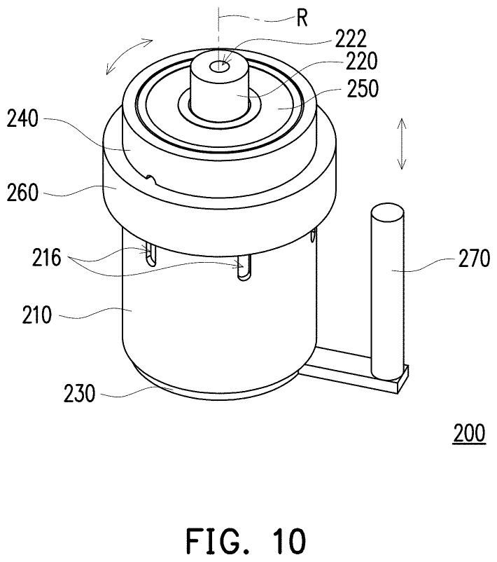

FIG. 10 is a schematic three-dimensional view of the energy beam supply device of FIG. 4 in another state. Refer to FIG. 4 to FIG. 6 and FIG. 10 at the same time. In the present embodiment, the outer wall of the gas channel selector 240 includes a groove 246, the outer wall of the rotating sleeve 210 includes a plurality of positioning grooves 216, and the energy beam supply device 200 further includes a fixing ring 260 slidably disposed on the gas channel selector 240 and the rotating sleeve 210. The inner wall of the fixing ring 260 includes a positioning protruding member 262 adapted to be inserted into the groove 246 of the gas channel selector 240 or one of the plurality of positioning grooves 216 of the rotating sleeve 210 along a direction parallel to the rotation axis R. Specifically, during the surface processing procedure, the fixing ring 260 is slid along a direction parallel to the rotation axis R to be inserted into one of the positioning grooves 216 of the rotating sleeve 210 via the positioning protruding member 262, so as to fix the relative positions of the rotating sleeve 210 and the gas channel selector 240 (i.e., the fixing ring 260 is temporarily combined with the rotating sleeve 210). When switching to use different openings 212 to supply the energy beam, the fixing ring 260 is first slid in the opposite direction to the above direction to separate the positioning protruding member 262 from the positioning grooves 216 of the rotating sleeve 210 and fit the positioning protruding member 262 into the groove 246 of the gas channel selector 240. Next, after the fixing ring 260 is rotated to drive and rotate gas channel selector 240 to the position of another positioning groove 216, the fixing ring 260 is slid in the above direction again to insert the positioning protruding member 262 into the other positioning groove 216 to fix the relative positions of the rotating sleeve 210 and the gas channel selector 240 (that is, the fixing ring 260 and the rotating sleeve 210 are temporarily combined). In other words, moving the fixing ring 260 drives the gas channel selector 240 to rotate together, so that the third gas flow channel 242 in the gas channel selector 240 corresponds to the first gas flow channel 214 to be switched. In the present embodiment, the spacings of the plurality of positioning grooves 216 may be designed to be the same, and the number of the plurality of positioning grooves 216 is the same as the number of the plurality of openings 212. In this way, the convenience of operating the fixing ring 260 may be improved. Further, in the present embodiment, the positioning protruding member 262 slides on the groove 246, but the two are not completely separated. The positions of the positioning grooves 216 may represent the position of the first gas flow channels 214, and the position of the positioning protruding member 262 may represent the position of the third gas flow channel 242.

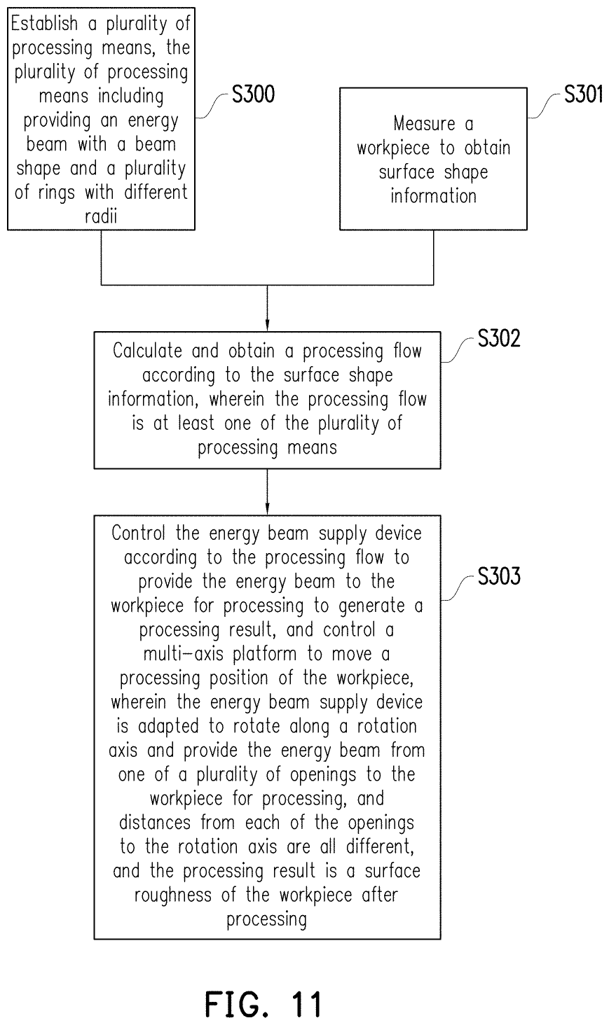

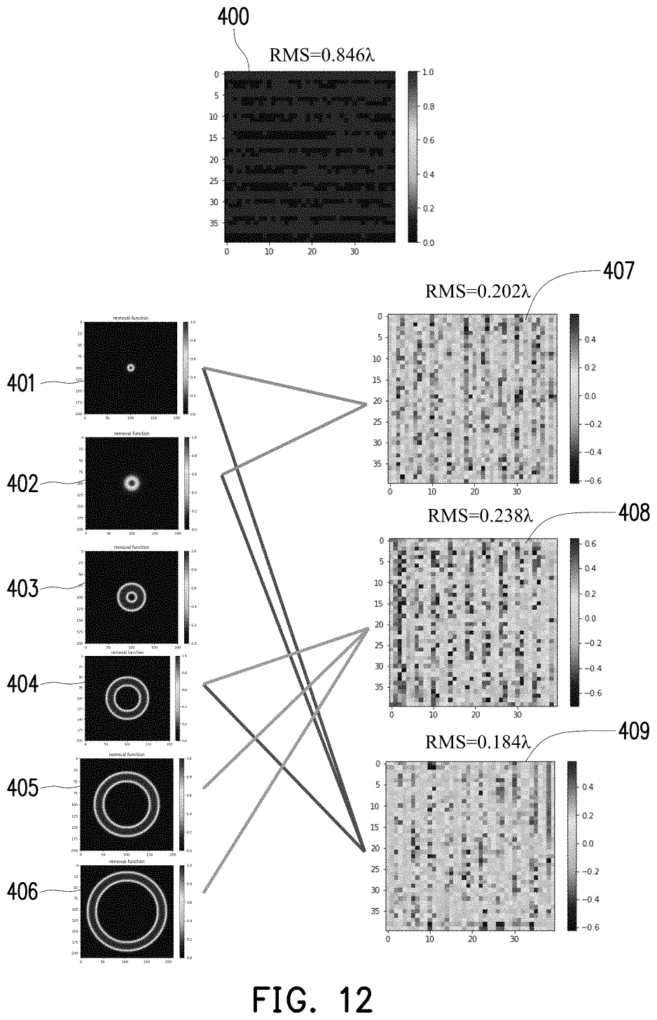

FIG. 11 is a flowchart of steps of a surface processing method of an embodiment of the disclosure. FIG. 12 is a schematic diagram of processing simulation of different energy beams of an embodiment of the disclosure. Please refer to FIG. 1A to FIG. 2 and FIG. 8A to FIG. 12 at the same time. In the present embodiment, the step flow of the surface processing method shown in FIG. 8 may be applied to at least the surface processing equipment 100 shown in FIG. 1A and FIG. 1B, so the following uses the surface processing equipment 100 shown in FIG. 1A and FIG. 1B as an example. In the surface processing procedure, first, step S300 may be performed to establish a plurality of machining sequence plans. In particular, the plurality of machining sequence plans include providing an energy beam having a beam shape and a plurality of rings having different radii. For example, in the present embodiment, the energy beam supply device 200 of the surface processing equipment 100 has six different machining sequence plans, and the machining sequence plans include providing the energy beam B having a beam shape and a plurality of rings having different radii, i.e., the energy beam B having six different shapes generated in FIG. 9A to FIG. 9F. The machining sequence plans may be simulated by the processing device 130 and the corresponding simulation results respectively obtained by the machining sequence plans may be stored. The simulation results of the energy beam B generated in FIG. 9A to FIG. 9F may be shown in a simulation graph 401 to a simulation graph 406 in FIG. 12, wherein the simulation graph 401 and the simulation graph 402 represent the simulation results of the machining sequence plans of FIG. 9A at different working distances (the working distance L shown in FIG. 2), and the simulation graph 403 to the simulation graph 406 show the simulation result of the ring-shaped energy beam B having different radii.

In addition, at the same time as the above steps, step S301 may be performed to measure the workpiece 10 to obtain surface form information. For example, in the present embodiment, for example, the workpiece 10 is processed to change the surface roughness of the workpiece; in detail, the workpiece 10 may be moved by the multi-axis platform 140 to the detection axis I of the measuring device 110 for measurement, in order to obtain surface form information (such as the height information of any position on the surface of the workpiece 10), and transmit the surface form information to the processing device 130 for storage, and the simulation graph 400 shows the surface height information of the workpiece 10, wherein RMS is expressed as root mean square, and the degree of surface roughness may be shown as RMS=0.846λ. In an embodiment, step S301 may be performed before step S300 or simultaneously with step S300, but the disclosure is not limited thereto.

Next, after the above steps S300 and S301 are completed, step S302 is performed to calculate and obtain the machining process according to the surface form information. In particular, the machining process is at least one of a plurality of machining sequence plans. For example, in the present embodiment, the processing device 130 may perform calculation according to the surface form information obtained in step S301 and the ideal surface form (i.e., the surface shape to ideal design values), so as to obtain a surface shape error. Next, at least one machining sequence plans desired is calculated according to the surface form error as the machining process. For example, from the processing simulation result of the simulation graph 407, it may be seen that the surface roughness of RMS=0.202λ may be obtained by sequentially processing using the machining sequence plans providing the beam-shaped energy beam B of, for example, the simulation graph 401 and the simulation graph 402 respectively. From the processing simulation result of the simulation graph 408, it may be seen that the surface roughness of RMS=0.238λ may be obtained by sequentially processing using the machining sequence plans providing the ring-shaped energy beam B of, for example, the simulation graph 404 to the simulation graph 406 respectively. From the processing simulation result of the simulation graph 409, a surface roughness of RMS=0.184λ may be obtained by sequentially processing using the composite machining sequence plans of, for example, the simulation graph 401, the simulation graph 402, and the simulation graph 404 providing beam-shaped and ring-shaped energy beams B respectively.

After the above steps are completed, step S303 is performed to control the energy beam supply device 200 according to the processing procedure to supply the energy beam B to the workpiece 10 for processing to generate a processing result, and control the multi-axis platform 140 to move the processing position of the workpiece 10. In particular, the energy beam supply device 200 is adapted to rotate along the rotation axis R and supply the energy beam B from one of the plurality of openings 212 to the workpiece 10 for processing. In particular, the processing result is the surface roughness of the workpiece 10 after processing. Specifically, after the above calculation is completed to determine the machining process, the processing device 130 controls the gas source 120 and the energy beam supply device 200 to perform the above machining process, the processing gas F is introduced into the opening 212 to be used by controlling the position of the third gas flow channel 242 in the gas channel selector 240, and at the same time, the power, time, and working distance of each of the processing procedures are set by the processing device 130. Moreover, the processing device 130 controls the multi-axis platform 140 to move the processing position of the workpiece 10 according to the above settings, so as to achieve precise processing.

Specifically, step S302 may be further subdivided to include the steps of: providing ideal surface form information; calculating the surface form information and the ideal surface form information to obtain surface form error information; and obtaining at least one machining sequence plans desired according to the surface form error information. The ideal surface form information is an ideal value of the desired surface roughness (for example, RMS≤0.1λ). The surface form error information is the degree of difference between the surface form information of the workpiece 10 and the ideal surface form information. Therefore, after the processing device 130 calculates the surface form error information, the processing device 130 calculates the optimal machining sequence plans according to the surface form error information, so as to perform the processing method with optimal efficiency. In addition, in different embodiments, step S302 may be performed for different areas of the surface of the workpiece 10 respectively. That is to say, the optimal machining process may be calculated for different areas respectively to carry out the processing procedure of different areas. In this way, different processing procedures may be applied according to the degree of roughness of different areas.

It is worth mentioning that, in the present embodiment, the surface processing method using the energy beam B may further include: establishing a machining target, and if the processing result is greater than the machining target, measuring the workpiece 10 repeatedly to obtain surface form information. Moreover, if the processing result is less than or equal to the machining target, the processing is stopped. The machining target is, for example, a preset target value of the surface roughness of the workpiece 10. In other words, after the processing is completed, step S301 may be performed again to measure the processed workpiece 10. If the surface form information measured again has not reached the machining target, steps S302 and S303 may be performed again as needed. In this way, the processing precision may be further improved, and at the same time, the processing procedure may be made more efficient. In other embodiments, the workpiece may be processed to change the chemical or physical properties of the workpiece surface, but the disclosure is not limited thereto.

Based on the above, in the surface processing equipment using the energy beam and the surface processing method of the disclosure, the surface processing equipment includes the measuring device, the energy beam supply device, the gas source, and the processing device. The measuring device is adapted to measure the surface of the workpiece to obtain surface form information. The energy beam supply device is adapted to provide the energy beam to the workpiece for processing. The processing device is electrically connected to the measuring device, the gas source, and the energy beam supply device, and controls the gas source and the energy beam supply device according to the surface form information. Therefore, the surface finishing process of the workpiece may be performed in a non-contact manner, such as surface form trimming, and the operating parameters of the energy beam supply device may be adjusted via the surface form information obtained by surface form measurement. In addition, the energy beam supply device is adapted to rotate along the rotation axis, and the energy beam may be formed into an energy beam having a beam shape or a plurality of rings having different radii via the rotation of the energy beam supply device for surface processing. In this way, the workpiece may be processed by the composite machining sequence plans of the beam-shaped energy beam and the ring-shaped energy beam.

It will be apparent to those skilled in the art that various modifications and variations may be made to the structure of the disclosed embodiments without departing from the scope or spirit of the disclosure. In view of the foregoing, it is intended that the disclosure cover modifications and variations of this disclosure provided they fall within the scope of the following claims and their equivalents.

What is claimed is:

1. A surface processing equipment using an energy beam, comprising:
a measuring device adapted to measure a workpiece to obtain surface form information;
a gas source adapted to provide a processing gas;
an energy beam supply device connected to the gas source and adapted to receive the processing gas to form an energy beam, the energy beam supply device comprising:
a rotating sleeve comprising a plurality of openings and a plurality of first gas flow channels respectively communicated with the plurality of openings, the plurality of openings are located on a bottom surface of the rotating sleeve, and a cylindrical symmetry center of the rotating sleeve has a rotation axis adapted to rotate along the rotation axis and provide the energy beam from one of the plurality of openings to the workpiece for processing;
a multi-axis platform adapted to carry the workpiece and move the workpiece to a detection shaft of the measuring device, or move the workpiece to a transmission path of the energy beam; and
a processing device electrically connected to the measuring device, the gas source, the energy beam supply device, and the multi-axis platform, and the processing device controls the gas source, the energy beam supply device, and the multi-axis platform according to the surface form information, wherein distances from each of the plurality of openings to the rotation axis are all different, and the energy beam is formed into one of a beam shape or a plurality of rings having different radii via a rotation of the energy beam supply device.

2. The surface processing equipment using the energy beam of claim 1, wherein the energy beam supply device further comprises:
a first electrode disposed in a space of the rotating sleeve, the first electrode comprising a gas inlet and a second gas flow channel communicated with the gas inlet;
a second electrode disposed on the bottom surface of the rotating sleeve, and the rotating sleeve is located between the first electrode and the second electrode; and
a gas channel selector rotatably disposed on a top of the rotating sleeve, the gas channel selector comprising a third gas flow channel and a blocking portion, and the gas channel selector is rotated so that the third gas flow channel is communicated between the second gas flow channel and one of the plurality of first gas flow channels, so that the blocking portion covers the rest of the plurality of first gas flow channels.

3. The surface processing equipment using the energy beam of claim 1, wherein a number of the plurality of first gas flow channels is the same as a number of the plurality of openings.

4. The surface processing equipment using the energy beam of claim 1, wherein lengths of the plurality of first gas flow channels are all different.

5. The surface processing equipment using the energy beam of claim 1, wherein each of the plurality of first gas flow channels comprises a first portion and a second portion, each of the first portions has a same length and is parallel to an extending direction of the rotating sleeve, and each of the second portions has different lengths and is perpendicular to the extending direction of the rotating sleeve.

6. The surface processing equipment using the energy beam of claim 5, wherein central angles of any two adjacent second portions are the same.

7. The surface processing equipment using the energy beam of claim 1, wherein sums of distances from each of the plurality of openings to the rotation axis and lengths of each of the plurality of corresponding first gas flow channels are all the same.

8. The surface processing equipment using the energy beam of claim 2, wherein the energy beam supply device further comprises:
at least one rotating bearing disposed between the gas channel selector and the rotating sleeve.

9. The surface processing equipment using the energy beam of claim 2, wherein an outer wall of the gas channel selector comprises a groove, an outer wall of the rotating sleeve comprises a plurality of positioning grooves, and the energy beam supply device further comprises:
a fixing ring slidably disposed on the gas channel selector and the rotating sleeve, and an inner wall of the fixing ring comprises a positioning protruding member adapted to be combined with the groove or one of the plurality of positioning grooves.

10. The surface processing equipment using the energy beam of claim 9, wherein spacings of the plurality of positioning grooves are the same.

11. The surface processing equipment using the energy beam of claim 9, wherein a number of the plurality of positioning grooves is the same as a number of the plurality of openings.

12. The surface processing equipment using the energy beam of claim 2, wherein the energy beam supply device further comprises:
a conductive structure connected to the second electrode.

13. A surface processing method using an energy beam, comprising:
establishing a plurality of machining sequence plans, the plurality of machining sequence plans comprising providing an energy beam having a beam shape and a plurality of rings having different radii;
measuring a workpiece to obtain surface form information;
calculating and obtaining a machining process according to the surface form information, wherein the machining process is at least one of the plurality of machining sequence plans; and
controlling an energy beam supply device according to the machining process to supply the energy beam to the workpiece for processing to generate a processing result, and controlling a multi-axis platform to move a processing position of the workpiece, wherein the energy beam supply device is adapted to rotate along a rotation axis and provide the energy beam from one of a plurality of openings to the workpiece for processing, and minimum distances from each of the plurality of openings to the rotation axis are all different.

14. The surface processing method using the energy beam of claim 13, wherein the step of calculating and obtaining the machining process according to the surface form information further comprises:
providing ideal surface form information;
calculating the surface form information and the ideal surface form information to obtain surface form error information; and
obtaining at least one of the plurality of machining sequence plans according to the surface form error information.

15. The surface processing method using the energy beam of claim 13, further comprising:
establishing a machining target, wherein the machining target is a preset target value of a surface roughness of the workpiece; and
measuring the workpiece repeatedly to obtain the surface form information in a case that the processing result is greater than the machining target, and stopping processing in a case that the processing result is less than or equal to the machining target.
